(19) United States
(12) Patent Application Publication
(10) Pub. No.: US 2004/0015775 A1
(43) Pub. Date: Jan. 22, 2004

(54) Systems and methods for improved accuracy of extracted digital content

(76) Inventors: Steven J. Simske, Fort Collins, CO (US); Roland John Burns, Santa Cruz, CA (US); Sheelagh Anne Hudleston, Bristol (GB)

Correspondence Address: HEWLETT-PACKARD COMPANY, Intellectual Property Administration, P.O. Box 272400, Fort Collins, CO, 80527-2400, US

(21) Appl. No.: 10/199,530

(22) Filed: Jul. 19, 2002

(51) Int. Cl. G06F 15/00

(52) U.S. Cl. 715/500

(57) ABSTRACT

A digital-content extractor comprises a data-acquisition device configured to generate a digital representation of a source, a data-extraction engine communicatively coupled to the data-acquisition device, the data-extraction engine configured to apply a combination of a plurality of digital-content extraction algorithms over the source, wherein the data-extraction engine is configured to automatically accommodate new data-extraction algorithms. A method for improving the accuracy of extracted digital content comprises reading a digital source, identifying the digital source by type, generating an acceptance level for each of a plurality of digital-content extraction algorithms based on a confidence value and a credibility rating associated with the accuracy of each of the plurality of digital-content extraction algorithms, and applying a combination of at least two of the plurality of digital-content extraction algorithms based on the acceptance level to thereby generate extracted digital content of the digital source.

### TECHNICAL FIELD

The present disclosure generally relates to systems and methods for generating data from a digital information source. More particularly, the invention relates to systems and methods for improving the accuracy of extracted digital content.

### BACKGROUND OF THE INVENTION

Digital-content extraction (DCE) is a catch phrase that encompasses the concept of deriving useful data (e.g., metadata) from a digital source. A digital source can be any of a variety of digital media, including but not limited to voice (i.e., speech), music, and other auditory data; images, including film and other two-dimensional data images; three-dimensional graphics; and the like.

Metadata is data about data. Metadata may describe how, when, and sometimes by whom, a particular set of data was collected, how the data is formatted, etc. Metadata is essential for understanding information stored in data warehouses.

Metadata is used by search engines to locate pertinent data related to search terms and/or other descriptors used to describe or characterize the underlying content.

There are numerous algorithms that can be used for extracting content from documents. Many of these are public domain, available on the Internet at various universities, commercial, and even personal Web sites. Many algorithms designed to perform digital content extractions are proprietary. The following are representative examples of DCE algorithms: a) speech recognition algorithms; b) optical character recognition (OCR), or text recognition, algorithms; c) page/document analysis algorithms; d) forms recognition packages; e) document template matching algorithms; f) search engines, semantic-based and otherwise, including Web spiders and “bots” (i.e., robots); and g) intelligent agents (e.g., expert systems).

A variety of highly developed, and therefore, high-value algorithms exist to resolve issues related to specific DCE problems. Intuitively, one ought to be able to combine the results from select data-extraction algorithms to improve the performance (i.e., the accuracy) of the resulting metadata. However, programmatic application of these algorithms is piece-meal. Consequently, the results often offer no improvement to an end user. For example, the combination of two or more OCR engines using a “voting scheme” or other simple combination mechanism often results in little or no improvement in performance. In some situations, DCE algorithm combination methodologies may even result in a decrease in performance when one compares the results of the algorithms separately executed over the data (i.e., a printed page) with the results from the combined algorithm. Conventional DCE algorithm combinations are often limited due to the nature of their designs.

### SUMMARY OF THE INVENTION

An embodiment of a digital-content extractor, comprises a data-acquisition device configured to generate a digital representation of a source, a data-extraction engine communicatively coupled to the data-acquisition device, the data-extraction engine configured to apply a combination of a plurality of digital-content extraction algorithms over the source, wherein the data-extraction engine is configured to accommodate new data-extraction algorithms.

An embodiment of a method for improving the accuracy of extracted digital content, comprises An embodiment of a method for improving the accuracy of extracted digital content, comprises reading a digital source, identifying the digital source by type, generating an acceptance level for each of a plurality of digital-content extraction algorithms based on a confidence value and a credibility rating associated with the accuracy of each of the plurality of digital-content extraction algorithms, and applying a combination of at least two of the plurality of digital-content extraction algorithms based on the acceptance level to thereby generate extracted digital content of the digital source.

### BRIEF DESCRIPTION OF THE DRAWINGS

Systems and methods for improving the accuracy of extracted digital content are illustrated by way of example and not limited by the implementations in the following drawings. The components in the drawings are not necessarily to scale, emphasis instead is placed upon clearly illustrating the principles of the present invention. Moreover, in the drawings, like reference numerals designate corresponding parts throughout the several views.

FIG. 1 is a schematic diagram illustrating a possible operational environment for embodiments of a data assessment system according to the present invention.

FIG. 2 is a functional block diagram of the computing device of FIG. 1.

FIG. 3 is a functional block diagram of an embodiment of an intelligent digital content extractor operable on the computing device of FIG. 2 according to the present invention.

FIG. 4 is a flow chart illustrating a method for improving the accuracy of extracted digital content that maybe realized by the intelligent digital content extractor of FIG. 3.

FIG. 5 is a flow chart illustrating an embodiment of a method for generating an optimal interpretation of a particular aspect of a source document leading to the production of metadata that may be realized by the intelligent digital content extractor of FIG. 3.

FIG. 6 is a flow chart illustrating an embodiment of a method for integrating a digital-content extraction algorithm in the intelligent digital content extractor of FIG. 3.

### DETAILED DESCRIPTION

An improved data assessment system, having been summarized above, reference will now be made in detail to the description of the invention as illustrated in the drawings. For clarity of presentation, the data assessment system and an embodiment of the underlying intelligent digital content extractor (IDCE) will be exemplified and described with focus on the generation of useful data from a two-dimensional digital source or “document.” A document can be obtained from an image acquisition device such as a scanner, a digital camera, or read into memory from a data storage device (e.g., in the form of a file).

Embodiments of the IDCE rely on several levels of data extraction sophistication, a broad set of intellect “elements,” and the ability to compare and contrast information across each of these levels. Each resulting network of digital-content extraction algorithms can in essence, think for itself, thus providing an automatic assessment capability that allows the IDCE to continue improving its data extraction capabilities.

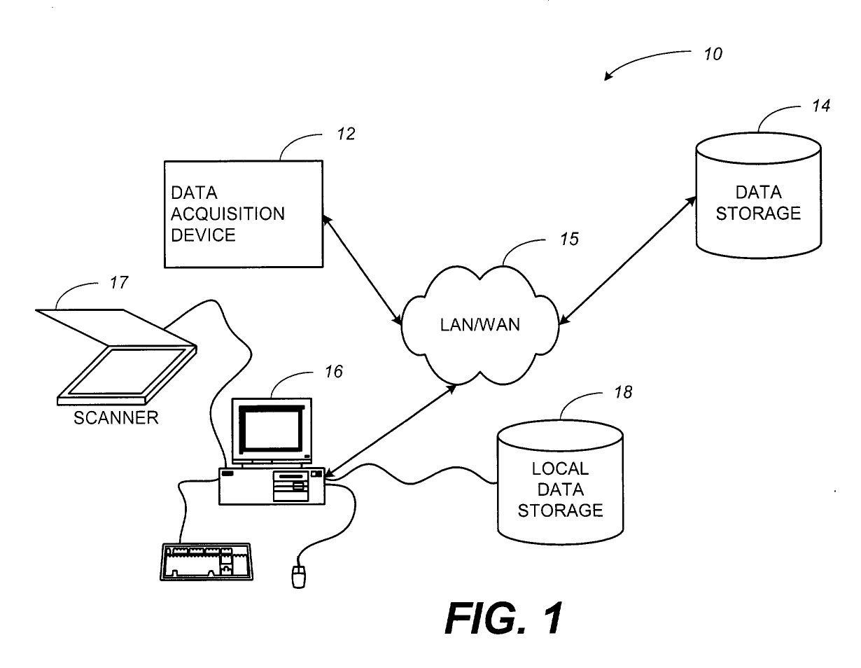

Turning now to the drawings, wherein like-referenced numerals designate corresponding parts throughout the drawings, reference is made to FIG. 1, which illustrates a schematic of an exemplary operational environment suited for a data assessment system. In this regard, a data assessment system is generally denoted by reference numeral 10 and may include a computing device 16 communicatively coupled with a scanner 17 and a local data storage device 18. As further illustrated in the schematic of FIG. 1, the data assessment system may include a remotely located data-acquisition device 12 and a remote data storage device 14 associated with the computing system 16 via local area network (LAN)/wide area network (WAN) 15.

The data assessment system 10 includes at least one data-acquisition device 12 (e.g., scanner 17) communicatively coupled with the computing device 16. In this regard, the data-acquisition device 12 can be any device capable of generating a digital representation of a source document. While the computing device 16 is associated with the scanner 17 in the illustration of FIG. 1, it should be appreciated that there are a host of image acquisition devices that may be communicatively coupled with the computing device 16 in order to transfer a digital representation of a document to the computing device 16. For example, the image acquisition device could be a digital camera, a video camera, a portable (i.e., hand-held) scanner, etc. In other embodiments, the underlying source data can take other forms than a two-dimensional document. For example, in some cases, the data may take the form of an audio recording (e.g., speech, music, and other auditory data), images, including film and other two-dimensional data images; three-dimensional graphics; and the like.

The network 15 can be any local area network (LAN) or wide area network (WAN). When the network 15 is configured as a LAN, the LAN could be configured as a ring network, a bus network, and/or a wireless local network. When the network 15 takes the form of a WAN, the WAN could be the public-switched telephone network, a proprietary network, and/or the public access WAN commonly known as the Internet.

Regardless of the actual network used in particular embodiments, data can be exchanged over the network 15 using various communication protocols. For example, transmission control protocol/Internet protocol (TCP/IP) may be used if the network 15 is the Internet. Proprietary image data communication protocols may be used when the network 15 is a proprietary LAN or WAN. While the data assessment system 10 is illustrated in FIG. 1 in connection with the network coupled data-acquisition device 12 and data storage device 14, the data assessment system 10 is not dependent upon network connectivity.

Those skilled in the art will appreciate that various portions of the data assessment system 10 can be implemented in hardware, software, firmware, or combinations thereof. In a preferred embodiment, the data assessment system 10 is implemented using a combination of hardware and software or firmware that is stored in memory and executed by a suitable instruction execution system. If implemented solely in hardware, as in an alternative embodiment, the data assessment system 10 can be implemented with any or a combination of technologies which are well-known in the art (e.g., discrete logic circuits, application specific integrated circuits (ASICs), programmable gate arrays (PGAs), field programmable gate arrays (FPGAs), etc.), or technologies later developed.

In a preferred embodiment, the data assessment system 10 is implemented via the combination of a computing device 16, a scanner 17, and a local data storage device 18. In this regard, local data storage device 18 can be an internal hard-disk drive, a magnetic tape drive, a compact-disk drive, and/or other data storage devices now known or later developed that can be made operable with computing device 16. In some embodiments, software instructions and/or data associated with the intelligent digital content extractor (IDCE) may be distributed across several of the above-mentioned data storage devices.

In a preferred embodiment, the IDCE is implemented in a combination of software and data executed and stored under the control of a computing processor. It should be noted, however, that the IDCE is not dependent upon the nature of the underlying computer in order to accomplish designated functions.

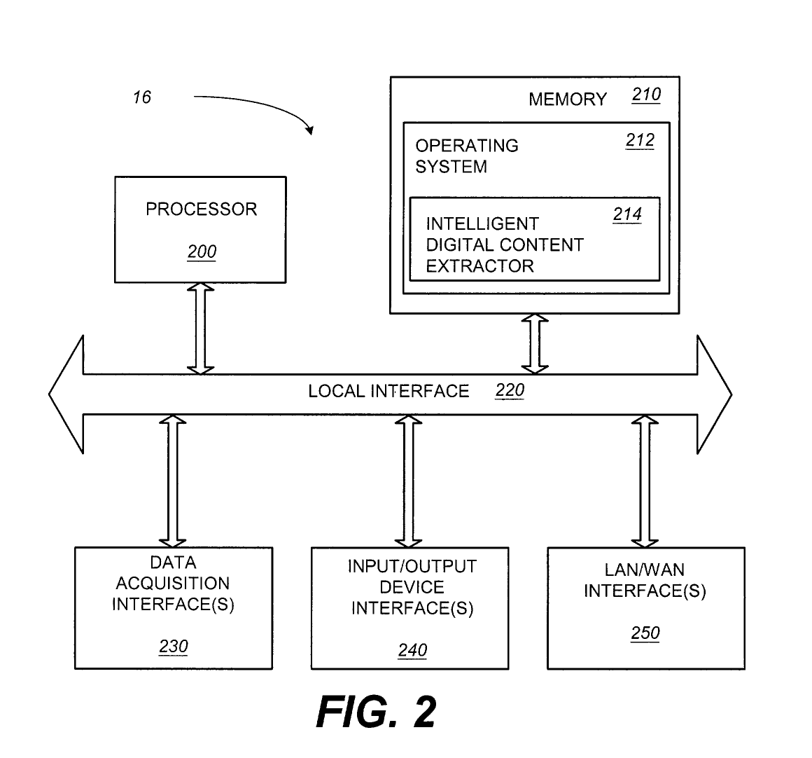

Reference is now directed to FIG. 2, which illustrates a functional block diagram of the computing device 16 of FIG. 1. Generally, in terms of hardware architecture, as shown in FIG. 2, the computing device 16 may include a processor 200, memory 210, data acquisition interface(s) 230, input/output device interface(s) 240, and LAN/WAN interface(s) 250 that are communicatively coupled via local interface 220. The local interface 220 can be, for example but not limited to, one or more buses or other wired or wireless connections, as is known in the art or may be later developed. The local interface 220 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

In the embodiment of FIG. 2, the processor 200 is a hardware device for executing software that can be stored in memory 210. The processor 200 can be any custom-made or commercially-available processor, a central processing unit (CPU) or an auxiliary processor among several processors associated with the computing device 16 and a semiconductor-based microprocessor (in the form of a microchip) or a macroprocessor.

The memory 210 can include any one or combination of volatile memory elements (e.g., random access memory (RAM, such as dynamic RAM or DRAM, static RAM or SRAM, etc.)) and nonvolatile memory elements (e.g., read-only memory (ROM), hard drives, tape drives, compact discs (CD-ROM), etc.). Moreover, the memory 210 may incorporate electronic, magnetic, optical, and/or other types of storage media now known or later developed. Note that the memory 210 can have a distributed architecture, where various components are situated remote from one another, but can be accessed by processor 200.

The software in memory 210 may include one or more separate programs, each of which comprises an ordered listing of executable instructions for implementing logical functions. In the example of FIG. 2, the software in the memory 210 includes IDCE 214 that functions as a result of and in accordance with operating system 212.

The operating system 212 preferably controls the execution of other computer programs, such as the intelligent digital content extractor (IDCE) 214, and provides scheduling, input-output control, file and data management, memory management, and communication control and related services.

In a preferred embodiment, IDCE 214 is one or more source programs, executable programs (object code), scripts, or other collections each comprising a set of instructions to be performed. It will be well-understood by one skilled in the art, after having become familiar with the teachings of the invention, that IDCE 214 may be written in a number of programming languages now known or later developed.

The input/output device interface(s) 240 may take the form of human/machine device interfaces for communicating via various devices, such as but not limited to, a keyboard, a mouse or other suitable pointing device, a microphone, etc. Furthermore, the input/output device interface(s) 240 may also include known or later developed output devices, for example but not limited to, a printer, a monitor, an external speaker, etc.

LAN/WAN interface(s) 250 may include a host of devices that may establish one or more communication sessions between the computing device 16 and LAN/WAN 15 (FIG. 1). LAN/WAN interface(s) 250 may include but are not limited to, a modulator/demodulator or modem (for accessing another device, system, or network); a radio frequency (RF) or other transceiver; a telephonic interface; a bridge; an optical interface; a router; etc. For simplicity of illustration and explanation, these aforementioned two-way communication devices are not shown.

When the computing device 16 is in operation, the processor 200 is configured to execute software stored within the memory 210, to communicate data to and from the memory 210, and to generally control operations of the computing device 16 pursuant to the software. The IDCE 214 and the operating system 212, in whole or in part, but typically the latter, are read by the processor 200, perhaps buffered within the processor 200, and then executed.

The IDCE 214 can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this disclosure, a “computer-readable medium” can be any means that can store, communicate, propagate, or transport a program for use by or in connection with the instruction execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

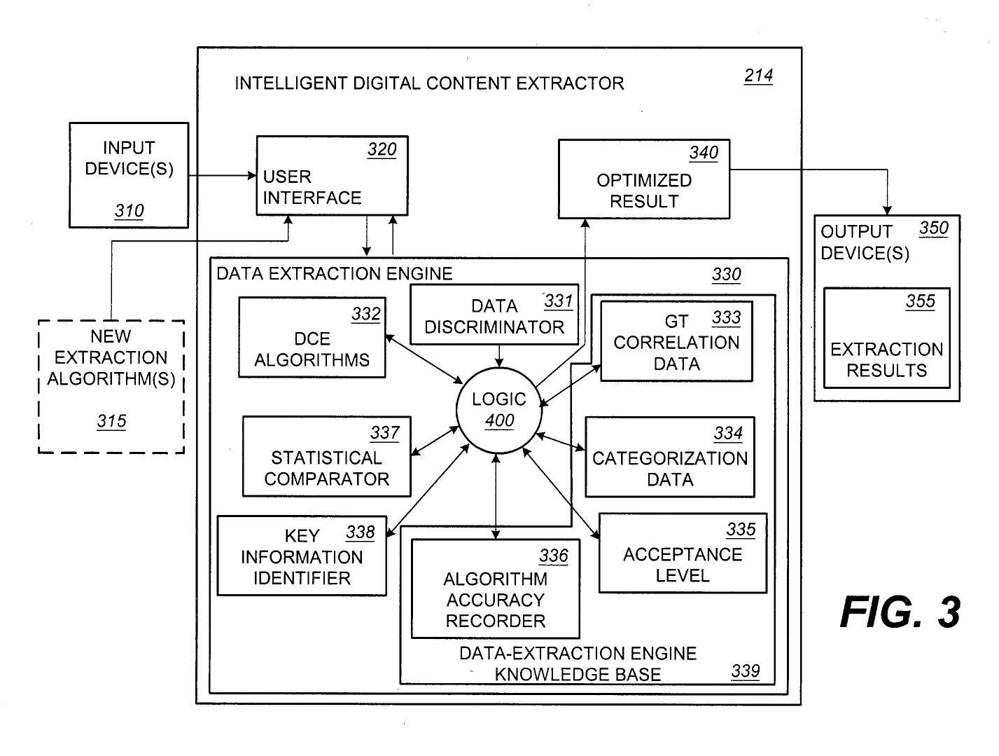

Reference is now directed to FIG. 3, which presents an embodiment of a functional block diagram of IDCE 214. As illustrated in FIG. 3, the IDCE 214 may comprise a user interface 320 and a data-extraction engine 330. IDCE 214 may receive data via various data input devices 310. When the input data originates from a printed document, the input device 310 may take the form of a scanner, such as the flatbed scanner 17 of FIG. 1. The scanner 17 may be used to acquire a digital representation of the printed document that is communicated to the data-extraction engine 330.

As further illustrated in the functional block diagram of FIG. 3, the data-extraction engine 330 may comprise a data discriminator 331, a plurality of DCE algorithms 332, an algorithm accuracy recorder 336, a statistical comparator 337, a key information identifier 338, and logic 400. Furthermore, the data-extraction engine 330 records various data values or scores based on interim processing performed by the data discriminator 331, the DCE algorithms 332, statistical comparator 337 and logic 400. For example, the data-extraction engine 330 records ground-truthing (GT) correlation data 333, categorization data 334, and acceptance level data values 335. Logic 400 coordinates data distribution to each of the various functional algorithms. Logic 400 also coordinates inter-algorithm processing and data transfers both between the data-extraction engine 330 and external devices (e.g., input devices 310) and between the various internal functional algorithms (e.g., the data discriminator 331, the DCE algorithms 332, the statistical comparator, and the like) and the various data types (e.g., the GT correlation data 333, the categorization data 334, the acceptance level 335, and the like).

The functional block diagram of FIG. 3 further illustrates that the data-extraction engine 330 may generate an optimized digital content extraction result 340 that may be forwarded to one or more output devices 350 to convey various data extraction results 355 to an operator of the IDCE 214.

To effectively communicate between the various DCE algorithms 332, logic 400 is configured to accept and process a set of common data-interchange standards. The data-interchange standards provide a framework of recognizable data types that each of the DCE algorithms 332 may use to define a data source (e.g., a document). These standards can include standards for zoning, layout, data and/or document type, and text standards, among others. Note that the data-interchange standards employed between a plurality of DCE algorithms 332 may vary depending on the specific DCE algorithms 332 that are communicating underlying document data.

Zoning is the classification and segmentation of various regions that may together comprise a data source. Various regions of a document may comprise areas containing text, photos, and specialized graphics such as a border or the like. In the case of a “scanned” magazine article, a single page may contain some or all of the aforementioned features. In order to accurately identify and classify the underlying data content, the various DCE algorithms 332 should be appropriately matched to portions of the data. In this regard, zoning is a method for targeting the application of the various DCE algorithms 332 over portions or segments of the underlying digital data where required. Electronically-formatted data such as .html, .xml, .doc and .pdf files, for example, should not require zoning. However, even fully electronically-generated documents may benefit from zoning for repurposing of their content for other domains (e.g., PDF to DHTML/HTML/XML+XSLT, etc.).

Layout can be described as the relative relationship between the underlying data. For example, in the context of a document, layout may include information reflective of such features as articles, columns within articles, titles separating articles, sub-titles separating portions of an article, and the like.

Data type can include a classification of the media upon which the acquired digital data originated. By way of example, digital documents may have been scanned or otherwise acquired from various media types, such as a “magazine page,” a “slide,” a “transparency,” etc.). It should be appreciated that information reflective of the media type may be used to select a particular DCE algorithm 332 that is well-suited for extracting digital content from that particular media type. In other cases, it may be possible to fine tune or otherwise adjust a DCE algorithm 332 in order to achieve more accurate results.

Text standards can include optical character recognition (OCR), synopses, grammar tagging, language identification, purpose of the text (e.g., photo credit, title, caption, etc.), text formatting, translation into other languages, and the like. Many of these standards exist already in public formats, such as HTML for rendering of text on web pages, PDF for rendering of pages to the screen and printers, DOC for rendering Microsoft Word documents, etc. However, the IDCE 214 herein described may use an abstract set of text-based standards that are independent of any particular format.

By using an abstract set of data-interchange standards, the IDCE 214 enables any algorithm that is useful in one of these areas (zoning, layout, document typing and text) or in a subset of one of these areas, to interact in a cooperative-yet-competitive fashion with other DCE algorithms 332 populating the same set of abstract interchange data (e.g., ground-truthing correlation data 333, categorization data 334, and acceptance level 335). Looking back to the data assessment system 10 illustrated in FIG. 1, it should be appreciated that the DCE algorithms 332 and the various other elements of the data-extraction engine 330 may be stored and operative on a single computing device or distributed among several memory devices under the coordination of a computing device.

Moreover, various information, such as but not limited to, the ground-truthing correlation data 333, the categorization data 334, the acceptance levels 335, and data in a algorithm accuracy recorder 336 illustrated in the functional block diagram of FIG. 3, may form a data-extraction engine knowledge base 339. Regardless of the actual implementation, the data-extraction engine knowledge base 339 contains the information that logic 400 uses to select and combine various DCE algorithms 332 to reach a data extraction result with improved accuracy.

In alternative embodiments, e.g., when the source data takes the form of an audio file, the data-interchange standards described above may be replaced in their entirety by a set of appropriate data-interchange standards suited for characterizing digital audio data rather than digital representations of print media. Other data-interchange standards may be selected for specific types of image based data (photos, film, graphics, etc.) Regardless of the underlying media and the data-interchange standards selected, in order for two or more DCE algorithms 332 and/or other portions of the data-extraction engine 330 to interface, the data-interchange standard selected preferably subscribes to at least one element that is commonly used by both algorithms.

As also illustrated in the function block diagram of FIG. 3, the IDCE 214 may integrate new extraction algorithms 315 for use in the data-extraction engine 330. In this regard, the IDCE 214 may automatically accommodate new DCE algorithms 315 as they become available to the IDCE 214. For the purposes of this disclosure, “accommodate” is defined to encompass one or more of at least the following features: a) the data-extraction engine 330 is configured such that new extraction algorithms 315 can subscribe to any subsets of the overall set of metadata that can be created; b) the data-extraction engine 330 can automatically compare the accuracy of any new extraction algorithms 315 to existing DCE algorithms 332 for any digital source; c) the data-extraction engine 330 is configured to accept and apply metrics describing a particular new extraction algorithm's performance (e.g., absolute and comparative) as new data enters the system; d) the data-extraction engine 330 can integrate each new extraction algorithm 315 into the IDCE 214 without affecting any of the DCE algorithms 332 already in the system.

While the functional block diagram presented in FIG. 3 illustrates an IDCE 214 having a single centrally-located data-extraction engine 330 with co-located logic 400 and functional elements, it should be appreciated that the various functional elements of the IDCE 214 may be distributed across multiple locations (e.g., with J2EE, .NET, enterprise Java beans, or other distributed computing technology). For example, various DCE algorithms 332 can exist in different locations, on different servers, on different operating systems, and in different computing environments because of the flexibility provided in that they interact via only common interchange data.

Because the highest levels of the interchange standards are concerned with the synopses (i.e., abstracts) of different documents and the correlation and interaction between documents, random queries, based on key phrases or other information extracted and/or generated in response to the documents, can be run against the knowledge base in automated attempts to formulate new relationships among the data. In turn, these new-found relationships may be recorded, tested, and where proven accurate, can be reflected in updates to the knowledge base of the IDCE 214. In this way, the IDCE 214 may continuously improve or “learn” over time.

The IDCE 214 may also generate new information via the use of coordinated searches for new correlations among documents. For example, related information in documents that are otherwise unrelated can be cross-correlated without the manual instantiation of a query or “search.” Coordinated searches could be triggered periodically based on time, date, the number of documents processed since the last cross-correlation check, or some other initiating criteria. Recently processed documents could be analyzed for key words, phrases, or other data. The key words, phrases, or other data could be used in a comparison with previously-processed documents. Any discovered matches result in a cross-correlation link between the source documents. Such correlations are stored within the IDCE system as invisible links (as opposed to visible links such as hyperlinks), or associations that exist but are not visible to the user.

Data-Extraction Engine Operation

The IDCE 214 has several levels of interaction, each of the levels is scalable, easily updated, and incrementally improved over time as each subsequent document is added to the knowledge base over time. The various levels of interaction include the following:

Ground-Truthing

An initial pool of representative digital media are hand-analyzed and “proofed” to obtain fully “ground-truthed” representations. Ground-truthing is the manual analysis that results in a highly accurate description of the interchange data for a particular document. The primary purpose of ground-truthing is to determine baseline data for comparing algorithm generated accuracy reporting statistics to establish accurate comparisons of the effectiveness of DCE algorithms 332. Ground-truthing data may include but are not limited by the following:

(a) Zoning: Zoning information that may be readily obtained from the user interface during ground-truthing are the region boundary (polygonal), page boundary (which provides border and margin information), the region type (text, photo, drawing, table, etc.), region skew, orientation, z-order, and color content.

(b) Layout: Layout elements may include groupings (articles, associated regions such as business graphics and photo credits, etc.), columns, headings, reading order, and a few specific types of text (e.g., address, signature, list, etc., where possible). Abstracts and nontext-region associated text (text written over another region, like a photo or film frame) may prove useful in layout ground-truthing, as well.

(c) Document Typing: Where possible, the document will be tagged as a specific type of document from a list that may include types such as “photo,” “transparency,” “journal article,” etc. Typing may further include subcategories. For example, a color photo, a black and white photo, a glossy-finished photo, etc., as may prove useful.

(d) Text: The language and individual words, lines, and paragraphs of text may be identified by OCR and/or other methods and manual inspection of the OCR results. Synopses, outlines, abstracts, and the like may be checked for accuracy. Where possible, grammar tags and translations will be ground-truthed. Formatting (e.g., font family, style, etc.) may be eliminated from the ground-truth for text as text formatting is a presentational issue important for final rendering.

Note that the relative usefulness of each of these ground-truthing data can be assessed by principal component analysis of the correlation matrices obtained for the correlation of algorithms with ground-truth results. In this way, non-useful correlates can be dropped and useful correlates that are clustered can be represented by a single correlation.

Ground-truth is an absolute measure of DCE algorithm 332 accuracy and effectiveness. It is, however, a manual process, and as such is expensive, poorly scalable, and may suffer value degradation as the number of documents in the corpus or database grows, and as the number of sub-categories grows.

Ground-truthing establishes a baseline performance statistic, as well as a credibility rating for the DCE algorithms 332, as described below. DCE algorithms 332 subscribing to a set of data-interchange standards may be tested against fully ground-truthed media to see how well they perform. They may also be rated for the subcategories of media types, as described in the following section.

Categorization

Categorization or identification of the digital-media types is a useful step in the selective application/generation of an improved digital-content extraction. The utility of ground-truthing (see above), performance statistics, and credibility ratings (see below) is enhanced when the overall set of digital media is subdivided or pre-categorized. Some pre-categorization can be done based on the media type (e.g., file-extension, hardware source, etc.) via the data discriminator 331.

Sub-categorization may be performed within the data-extraction engine 330 for refinement of scope. Digital media can be sub-categorized based on their media type, their classification/segmentation characteristics, their layout, etc. Even simple classification, segmentation, layout, etc., schemes can be used for this sub-categorization. An example is the use of a simple zoning algorithm that consists solely of a non-overlapping (“Manhattan layout”) segmentation algorithm (“segmenter”), a “text” vs. “non-text solid” vs. “non-text non-solid” region classifier, and a simple column/title layout scheme. While such a simple zoning/layout algorithm is not generally very useful for extracting metadata from digital documents, it is useful in sub-categorization. The embodiment of an IDCE 214 described herein uses such a “reduced” or “partial” zoning+layout scheme to sub-categorize incoming documents, in addition to the media-format typing as described above.

Further sub-categorization can be achieved using simple relative document classification schemes such as a document clustering scheme, neural network classification, super-threshold pixel centroids and moments, and/or other public-domain techniques. The data discriminator 331 may also perform these and other sub-categorization or sorting operations.

Applicable document-clustering schemes include but are not limited to thresholding, smearing, region-distribution profiling, etc. These and other sub-categorization techniques allow the refinement of the statistics described below. For example, a certain layout algorithm may perform well on journal articles but poorly on magazine articles, the two of which are unlikely to be clustered together. The specific layout algorithm will therefore have higher performance and credibility statistics generated for its “journal article” sub-category than for its “magazine article” sub-category.

It should be appreciated that the data discriminator 331 enables the automatic localization of the various DCE algorithms 332 designed to extract information from specific data sources. Thus prohibiting the application of a DCE algorithm 332 designed to extract information from an audio recording to a data source identified as a printed document. Consequently, the IDCE 214 may apply DCE algorithms 332 designed to extract information from a printed document to appropriate data sources.

The DCE algorithms 332 may be readily adapted and applied to documents of any language. There are no language-specific limitations. However, in the case of OCR data extractors, it is preferred to match the printed language with the language of the OCR engine. This can be accomplished by finding the highest percentage of matched words to dictionaries for each of the languages in the set, or by other methods.

Published Performance Statistics

The data-extraction engine 330 is constructed to post a confidence statistic for each DCE algorithm 332. This statistical baseline for performance can be described as a p-value [p range 0 to 1], where p=1.00 implies that the algorithm is 100% confident in its results. DCE algorithms 332 that may not be (a) public domain, (b) readily retrofitted to generate such statistics, or (c) innately poor in comparing their results for different cases, can be assigned a default p-value (e.g., a default p-value of 0.50 is suggested, but any value greater than zero and less than or equal to 1.00 will suffice.) It should be appreciated that the posted confidence statistic for each particular DCE algorithm 332 may be specific to each category and/or sub-category. Consequently, a plurality of posted confidence statistics may be applicable for each DCE algorithm 332. Regardless, of the specific number of posted confidence statistic values associated with each particular DCE algorithm 332, logic 400 may apply the appropriate statistic as indicated by the data discriminator 331.

Credibility Ratings

Sophisticated DCE algorithms 332 will have the ability to assess their “published statistics” or p-value in light of each new media instance (e.g., for each new document). Less sophisticated DCE algorithms 332, as described in the preceding section, will have the same published statistics irrespective of the document. Unfortunately, a poorly-characterized DCE algorithm 332 may report a default statistic or a higher statistic than is appropriate, while a well-characterized DCE algorithm 332, in making an honest assessment, may report a lower statistic even when it will surely outperform the poorly-characterized DCE algorithm 332.

To account for possible discrepancies between the “published statistic” or p-value and the actual ability of a particular DCE algorithm 332 to perform on a particular document, a credibility rating may be generated for each algorithm. The existence of ground-truthed documents can be used to generate the credibility rating. New extraction algorithms 315, upon entry into the IDCE 214, are automatically compared to ground-truth results by performing a “trial” analysis on ground-truthed documents. It should be appreciated that both the ground-truth correlation data 333 and the published p-value for the new extraction algorithm 315 can be used as an estimate of the expected performance of the new extraction algorithm(s) 315. This correlation of the new extraction-algorithm performance with ground-truth can be performed on each sub-category of documents in the ground-truth set. The correlation with ground-truth information can be used to generate the credibility rating of the new extraction algorithm 315. In the absence of sufficient ground-truth information, correlating partial algorithms and/or inter-algorithm comparison (both described below) may be used to automatically improve the estimate of credibility.

Acceptance Levels

The data-extraction engine 330 is constructed to generate an acceptance-level statistic for each DCE algorithm 332. This statistical derivation for expected data-extraction accuracy of performance is generated as a function of the credibility rating and the published confidence statistic of the particular DCE algorithm 332. In its simplest form, the acceptance level 335 is a simple mathematical combination of the credibility rating and the published confidence statistic. In one embodiment, the acceptance level 335 may be a multiplication of the published confidence level and the credibility rating (see above).

Despite the corrective nature of the acceptance level 335, further normalization of the published statistics is contemplated. This normalization, like other aspects of the IDCE 214, is readily updated as more and more documents are added to the system. Essentially, the normalization accounts for DCE algorithms 332 that over-report their expected performance in their published confidence statistics or p-values. Note that each DCE algorithm 332 may have a plurality of p-values associated with various categories and/or sub-categories of source data types. Preferably, the DCE algorithms' p-values are adjusted to have the same mean published statistic when averaged over all of the documents in the corpus. In this way, the credibility rating still dictates which DCE algorithms 332 have overall higher credibility. It will be understood by those skilled in the art of the present invention that IDCE 214 may apply a confirmed confidence statistic as an alternative to normalizing a published confidence statistic that incorrectly reflects the effectiveness of the respective DCE algorithm 332.

For example, suppose algorithm (A) has a mean credibility rating of 0.95, and algorithm (B) has a mean credibility rating of 0.85. For the purposes of this example, algorithm (A) is also sophisticated enough to rate its published statistics relatively (from 0.00 to 1.00, with a mean of 0.75), while algorithm (B) decides that it will always post a statistic of 1.00. Relative to algorithm (A), then, algorithm (B)'s published statistic should be adjusted by a factor of 0.75. This adjustment can be implemented as described above by applying the adjustment factor to the published statistic, or alternatively correcting (i.e., replacing) the published statistic with a more accurate value.

Now, suppose a document is tested by both algorithms. Algorithm (A) publishes a statistic of 0.85 and has a credibility rating of 0.9 for this particular document. Algorithm (B) publishes the p-value of 1.00 (as it always does) and has a credibility rating of 0.9 for this document. The acceptance level of (A) is 0.85×0.9=0.765, while that of (B) is 1.00×0.9×0.75 (the latter normalizing factor to account for its credibility)=0.675.

Each of the previously described data-extraction engine elements enables a methodology to optimally-analyze digital sources to extract information for the generation of useful metadata. In this methodology, new extraction algorithms 315 are seamlessly integrated into the IDCE 214, cooperating with and competing with existing DCE algorithms 332 in the determination of the most accurate metadata description for the particular data source. As previously described, each of the data-extraction engine elements functions via commonality in a set of data-interchange standards that bridge the gaps between each of the particular elements and the other elements of the data-extraction engine 330.

Partial or correlating algorithms share some similarities to “sub-categorization schemes” as described above. These partial or correlating algorithms provide predictive behavior for the complete or “full” algorithms when ground-truthing is either not possible, feasible, or desirable (i.e., in most cases!). These partial algorithms can in some cases provide a statistical indication of how well any algorithm (e.g., DCE algorithms 332 and/or new extraction algorithms 315) that have been entered into the IDCE 214 will perform on a previously-unexamined document. This is possible especially if there is a correlation between the “full” algorithm and the partial algorithm and when there is a correlation between the “full” algorithm and the ground-truth data.

However, partial algorithms will not always provide useful predictive value for the correlation of a “full” algorithm with ground-truth. In such cases, the partial algorithms can be useful for winnowing out “full” algorithms that are likely to be the most accurate in their analysis. Partial algorithms solve a simplified subset of the metadata generation problem, and in doing so, can identify “full” algorithm failures.

Using the Manhattan segmenter again, for example, is illustrative. A Manhattan segmenter simplifies the segmentation by forming non-overlapping rectangles. Thus, in even moderately complex page layouts, a Manhattan segmenter results in a simplification of segmentation, since any regions that may overlap another region's rectangular bounding box get added to the region until no rectangles overlap. Often, for magazine pages, etc., this results in columns or even an entire magazine page being reduced to a single region. Thus, if a full algorithm provides a region that overlaps two or more Manhattan regions, it is highly likely that this is because the full algorithm has erred and inadvertently smeared two regions together.

A priori, it would seem likely that if enough DCE algorithms 332 populate a given data-interchange standard area, such as layout determination for example, that they would tend to “cluster” on an optimal solution. This may well be the case in certain areas, such as OCR. However, for difficult documents, it is likely that many, if not most, algorithms will tend to fail because of similar misconceptions or design choices. In these cases, it may actually be the algorithms that do not cluster that provide the best solution for the problem. In these situations, the existence of ground-truth data will be of use. How the different algorithms cluster and correlate for similarly-structured (or “sub-categorized”) documents can be determined by looking at the ground-truth set. These tendencies, which are automatically updated as new algorithms or new ground-truthed documents are entered into the system, can then be used to winnow out the appropriate algorithms during an “inter-algorithm consideration” stage.

A comment on combining algorithms may prove useful here. In some cases (e.g., zoning and text analysis), regions and words (respectively) may be formed that did not exist in any of the individual algorithms. Using text extractors as an example, suppose the sentence “The Mormon keystone.” was analyzed by one OCR engine as “Themor monkey stone.” and by another OCR engine as “The Morm on keystone.” When the two algorithms are analyzed by logic 400 for combining, the sentence may be broken down into its most basic (e.g., the shortest) text pieces based on where word breaks (i.e., spaces) were found in any of the OCR engines: “The morm on key stone.” From this last arrangement, new words not originally present in either OCR interpretation, such as “Mormon” and “onkey,” can be formed, providing a means to correctly parse the sentence not separately available in either OCR engine.

A similar “emergent” region is possible for zoning. Suppose a document comprises two text columns, referred to here as regions “1” and “2,” and a photo, referred to here as region “3” is located between regions 1 and 2 (overlapping their rectangular bounds). Suppose one zoning algorithm smears the photo together with region 1, and the other with region 3. That is, one zoning algorithm segments the document into two regions, “1+3” and “2.” The other zoning algorithm segments the document into regions, “1” and “2+3,” respectively. The new region emerges by subtracting the second algorithm's “1” from the first algorithm's “1+3” and/or by subtracting the first algorithm's “2” from the second algorithms “2+3.” This method for combining the results from multiple algorithms is referred to as “atomize and cluster.”

The IDCE 214 offers an opportunity for synergistic improvement in performance over that possible by simply selecting the most accurate single DCE algorithm 332 available for a particular source-data type. As described above, the “atomize and cluster” method for combining algorithms offers the possibility for solving problems that no single algorithm can solve. Many combining techniques, such as voting for OCR, may improve the overall accuracy of a set of algorithms by continually selecting the “best” of multiple existing results. However, this atomize and cluster technique provides the emergent capability of providing more accurate results even when no single DCE algorithm has in fact found the correct result. The examples given above for “The Mormon keystone” and zoning regions “1,” “2,” and “3” are testament to this.

While the full implementation of the optimized statistical combination of DCE algorithms 332 is very complex, in concept it is straightforward. Since all algorithms publish their statistical confidences in their findings, differences between different algorithms can be statistically compared and an optimized solution (e.g., using a cost function based on the data-interchange standards of the algorithms) involving results, where appropriate, from any subscribing algorithms, can be crafted. Such a solution is made possible by the use of statistical publishing by each of the DCE algorithms 332.

As new documents are added to the knowledge base of the IDCE 214, high-weight or high-priority key words may be generated from the text, if any exists, of the new documents. These keywords may trigger automatic queries into the knowledge base to generate a correlation analysis among various documents. This process may be automated, can be run at any time (e.g., during spare processor cycles, in “batch mode,” etc.), and can be used to generate new data not located in any single document within the corpus, or knowledge base 339.

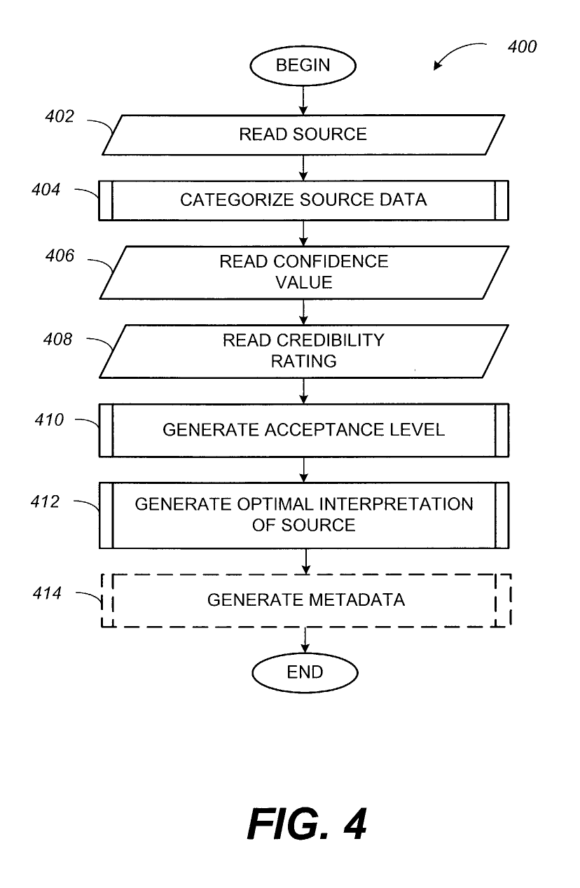

Reference is now directed to the flow chart illustrated in FIG. 4. In this regard, the various steps shown in the flow chart present a method for improving the accuracy of extracted digital content that may be realized by IDCE 214. As illustrated in FIG. 4, the method 400 may begin by reading and/or otherwise acquiring source data as shown in step 402. Next, the source data received in step 402 may be analyzed and one or more categories/sub-categories may be associated with the source data as illustrated in step 404.

After having received and identified the source data in steps 402 and 404, the IDCE 214 may read a confidence value as indicated in step 406. The IDCE 214 may also read a credibility rating as illustrated in step 408. After having read a confidence value and a credibility rating for each of a plurality of applicable DCE algorithms 332 when applied to the identified source data, as illustrated in steps 406 and 408, the IDCE 214 may generate an acceptance level for each DCE algorithm 332 as indicated in step 410. After having generated an acceptance level responsive to the confidence value and credibility rating of steps 406 and 408, the IDCE 214 may generate an optimal interpretation of the source data as illustrated in step 412.

As previously explained, an optimal interpretation of the source data may comprise the interaction of a data discriminator 331, a plurality of DCE algorithms 332, ground-truthing correlation data 333, categorization data 334, the acceptance level generated in step 410, an algorithm accuracy recorder 336, a statistical comparator 337, and a key information identifier 338. As also described above, the various elements that interact to generate the optimal interpretation of the source data may each interact with the other elements via commonality in a set of data-interchange standards that bridge the gaps between each of the particular elements and the other elements of the data-extraction engine 330. Moreover, the optimal interpretation may be responsive to partial or correlating algorithms, inter-algorithm considerations, statistical analysis and combination, and generation of metadata.

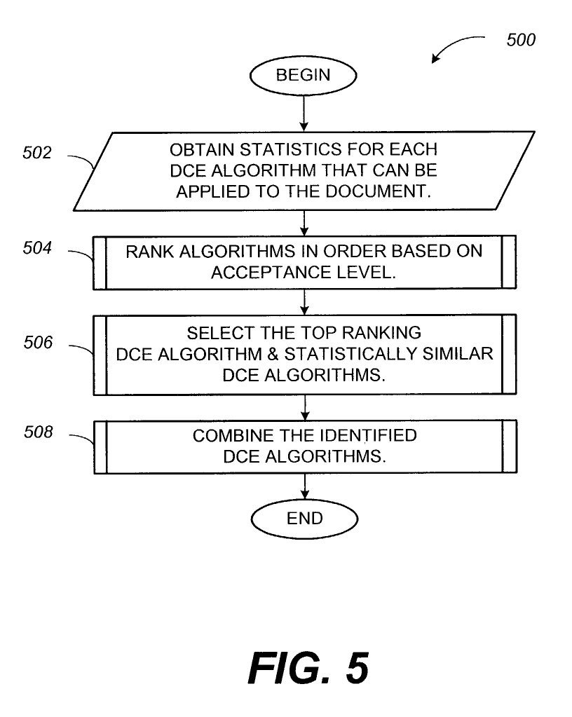

FIG. 5 is a flow chart illustrating an embodiment of a method for generating an optimal interpretation of a source document that may be realized by IDCE 214. In this regard, the various steps shown in the flow chart present a method for combining DCE algorithms for improving the accuracy of extracted digital content that may be realized by IDCE 214. As illustrated in FIG. 5, the method 500 may begin by reading and/or otherwise acquiring performance statistics associated with each of the various DCE algorithms that may be applied over a particular document of interest as shown in step 502. Next, the IDCE 214 may be programmed to rank the various DCE algorithms in order based on their respective acceptance level as shown in step 504.

After having identified and ranked the various DCE algorithms in steps 502 and 504, the IDCE 214 (FIG. 3) may perform a statistical test on the obtained statistics to determine which of any of the various DCE algorithms is statistically dissimilar from the others. As illustrated in step 506, the IDCE 214 may be programmed to select statistically similar DCE algorithms.

One way that this can be accomplished is to calculate a t-value and apply the t-value to a standard t-test to determine if results from the DCE algorithms are statistically different from one another. The t-test assesses whether the means of two groups are statistically different from each other. This analysis is appropriate whenever you want to compare the means of two groups. The t-value can be determined from the following equation:

$$t = \frac{{\overline{X}}_{1} - {\overline{X}}_{2}}{\sqrt{\frac{{Var}_{1}}{( {n}_{1} - 1 )} + \frac{{Var}_{2}}{( {n}_{2} - 1 )}}} , \qquad Eq . ( 1 )$$

where, \overline{X}, is the mean, Var, is the variance, n, the number of samples for each of the respective DCE algorithms, and the subscript “1” identifies the corresponding values from the top ranked DCE algorithm. For situations where results from more than two DCE algorithms need to be compared, the top-ranked DCE algorithm may be compared to results from subsequent DCE algorithms one at a time. As is evident from equation (1) above, the t-value will be positive if the first mean is larger than the second, and negative when it is smaller.

Generally, once the t-value has been computed it may be compared to a table of significance to test whether the ratio is large enough to indicate that the difference between the results generated by the DCE algorithms is not likely to have been a chance finding. In order to test the t-value against a table of significance, the number of degrees of freedom is preferably computed and a risk level (i.e., an alpha level) selected. In the t-test, the degrees of freedom is equivalent to the sum of the samples in both groups minus 2. In most social research, the “rule of thumb” is to set the risk level at 0.05. With a risk level of 0.05, five times out of a hundred the t-test would identify a statistically significant difference between the means even if there was none (i.e., by “chance.”)

Given the risk or alpha level, the degrees of freedom, and the t-value, one can look the t-value up in a standard table of significance (often available as an appendix in the back of most statistics texts) to determine whether the t-value is large enough to be significant. When it is, the difference between the means for the two groups is different (even given the variability). Statistical-analysis computer programs routinely provide the significance test results. After having statistically identified similar DCE algorithms as described above, the IDCE 214 may be programmed to combine the similar DCE algorithms as indicated in step 508.

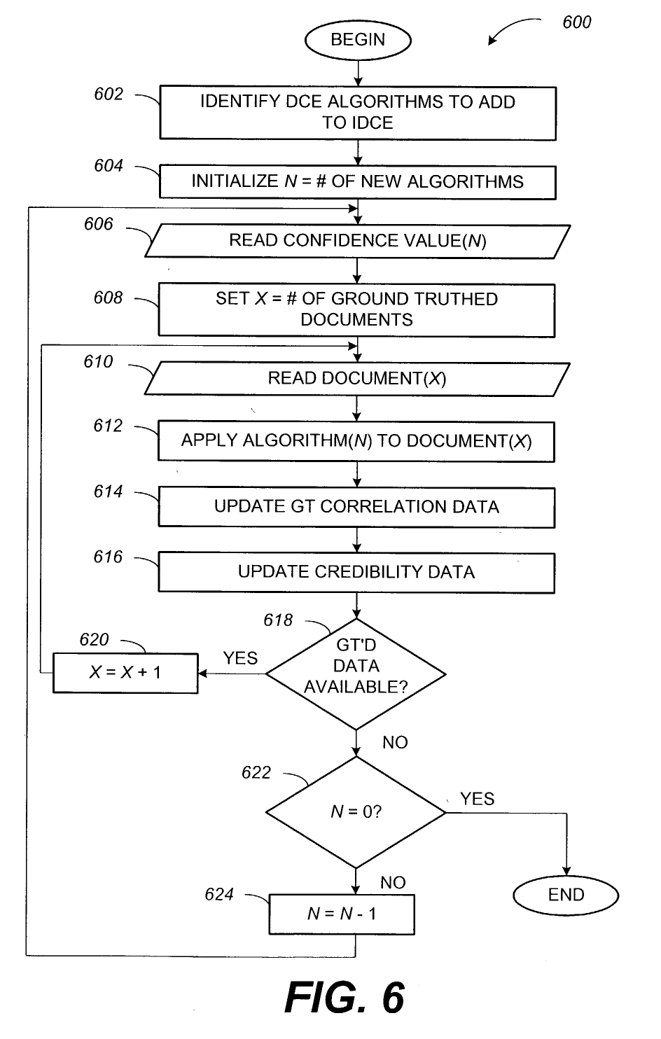

Reference is now directed to the flow chart illustrated in FIG. 6, which illustrates an embodiment of a method for integrating digital-content extraction algorithms in the intelligent digital content extractor of FIG. 3. In this regard, DCE algorithm integration logic herein illustrated as method 600 may begin with step 602 where a user of the IDCE 214 identifies one or more DCE algorithms 332 (see FIG. 3) that the user desires to add to the IDCE 214. Next, in step 604, the integration logic may set a counter, N, equal to the number of DCE algorithms 332 that the user desires to integrate with the IDCE 214. As illustrated in step 606, the integration logic may read a published confidence value. It should be appreciated that in some cases, the new DCE algorithm may publish a confidence value for a number of various source data types. For example, an algorithm designed to extract digital content from a digital photo may provide confidence values for various digital photograph file formats.

Next, as illustrated in step 608, the integration logic may search for the number of ground-truthed data sources in the IDCE knowledge base related to the present DCE algorithm. Once the integration logic has identified the type of data source that the DCE algorithm 332 is designed to extract from, the integration logic may begin reading each of the ground-truthed data files or documents as shown in step 610. The integration logic may proceed by applying the underlying DCE algorithm 332 to the ground-truthed data presently in memory as shown in step 612. As illustrated in step 614, the results of comparison to the ground-truthed data may be used to update the GT correlation data. Similarly, as illustrated in step 616, the integration logic can update the credibility data.

Thereafter, as illustrated in step 618, the integration logic may query the knowledge base if further ground-truthed data source examples are available. If the response to the query of step 618 is affirmative, i.e., more ground-truthed data sources exist, the integration logic may update a counter as shown in step 620 and return to step 610. As shown in the flow chart of FIG. 6, the integration logic may perform steps 610 through 620 until a determination has been made that the entire set of ground-truthed data sources has been processed.

Otherwise, if the response to the query of step 618 is negative, i.e., the set of ground-truthed data sources that match the type of data that the DCE algorithm is targeted to extract information from, the integration logic may perform a second query as illustrated in step 622. As illustrated in the flow chart of FIG. 6, if there are more DCE algorithms to integrate into the IDCE 214, as indicated by the negative branch exiting the query of step 622, the integration logic may decrement a counter as shown in step 624 and repeat steps 606 through 624 to assimilate the remaining DCE algorithms identified for integration. As is also illustrated in the flow chart of FIG. 6, if the response to the query of step 622 is affirmative, i.e., all the new algorithms have been added to the system, the integration logic may terminate.

It should be appreciated that the integration logic may report or otherwise communicate with other elements of the IDCE 214. In this regard, the integration logic may forward identifiers of the newly-integrated DCE algorithms, together with published confidence values, credibility values, etc. In this way, IDCE 214 can integrate any number of algorithms.

As described above, each new DCE algorithm 315 (see FIG. 3) integrated with IDCE 214 may not accurately report its own absolute credibility. Stated another way, the IDCE 214 uses the ground-truthing information and various pertinent information resident in the knowledge base 339 to derive a normalized credibility rating. It is significant to note that sophisticated DCE algorithms 332 can still report relative statistics that indicate their relative effectiveness on different types of documents.

In addition to the ability to integrate new DCE algorithms 332, as illustrated and described in association with the flow chart of FIG. 6, it should be appreciated that as new documents (i.e., data sources) are entered into the IDCE 214, and as new ground-truthing is performed, the knowledge base 339 of the IDCE 214 is further expanded. For example, information responsive to data source categorization and/or sub-categorizations may be automatically updated. Where appropriate, ground-truthing, credibility statistics, acceptance levels, and query-generated statistics may be updated further changing the IDCE 214 knowledge base 339.

Any process descriptions or blocks in the flow charts presented in FIGS. 4, 5, and 6, should be understood to represent modules, segments, or portions of code or logic, which include one or more executable instructions for implementing specific logical functions or steps in the associated process. Alternate implementations are included within the scope of the present invention in which functions may be executed out of order from that shown or discussed, including substantially concurrently or in reverse order, depending on the functionality involved, as would be understood by those reasonably skilled in the art after having become familiar with the teachings of the present invention.

We claim:

1. A digital content extractor, comprising:
a data-acquisition device configured to generate a digital representation of a source;
a data-extraction engine communicatively coupled to the data-acquisition device, the data-extraction engine configured to apply a combination of a plurality of digital-content extraction algorithms over the source, wherein the data-extraction engine is configured to automatically accommodate new data-extraction algorithms.

2. The extractor of claim 1, wherein the data-extraction engine determines a more accurate interpretation of digital content within the source than can be realized by separately applying each respective digital-content extraction algorithm.

3. The extractor of claim 1, wherein the data-extraction engine compares the relative effectiveness of the plurality of digital-content extraction algorithms in response to a verification that the combined digital-content extraction algorithms share a common data type identified in a data-interchange standard.

4. The extractor of claim 1, wherein the data-extraction engine applies the combination of the plurality of digital-content extraction algorithms in response to information in a knowledge base.

5. The extractor of claim 1, wherein the data-extraction engine applies a select combination formed from the plurality of digital-content extraction algorithms in response to a statistically-driven comparison of expected results.

6. The extractor of claim 1, wherein the data-extraction engine applies the combination of the plurality of digital-content extraction algorithms in response to an identified data type in the source.

7. The extractor of claim 4, wherein the knowledge base comprises information responsive to the prior application of a particular digital-content extraction algorithm over an identified source.

8. The extractor of claim 4, wherein the knowledge base comprises an acceptance level reflective of each individual digital-content extraction algorithm's verified ability to correctly interpret content within the source.

9. The extractor of claim 4, wherein the knowledge base comprises an acceptance level that comprises a function of a confidence value reflective of each individual digital-content extraction algorithm's ability to interpret the source.

10. The extractor of claim 4, wherein the knowledge-base comprises an acceptance level that comprises a function of a credibility rating reflective of each individual digital-content extraction algorithm's verified ability to interpret the source.

11. The extractor of claim 4, wherein the knowledge-base comprises an acceptance level that is generated via a mathematical combination of a confidence value and a credibility rating.

12. An improved digital content extractor, comprising:
a plurality of means for extracting digital content from a source;
means for verifying the accuracy of the digital content extracted from each of the plurality of means for extracting;
means for identifying a source data type; and
means for adaptively applying a combination of the plurality of means for extracting responsive to the means for confirming and the means for identifying.

13. The extractor of claim 12, further comprising means for confirming a data-interchange standard associated with each of the plurality of means for extracting.

14. The extractor of claim 12, further comprising means for reporting the result of the means for adaptively applying.

15. The extractor of claim 14, further comprising means for updating the means for verifying responsive to the means for reporting.

16. The extractor of claim 12, wherein the plurality of means for extracting digital content comprises a set of digital-content extraction algorithms.

17. The extractor of claim 12, wherein the means for verifying comprises a result comparison with verified source data.

18. The extractor of claim 17, wherein the means for verifying comprises a manual comparison of the result with the underlying content within the source data.

19. The extractor of claim 12, wherein the means for identifying a source type generates a source category identifier.

20. The extractor of claim 12, wherein the means for adaptively applying further comprises a statistical comparison of the expected accuracy of the plurality of means for extracting digital content.

21. The extractor of claim 12, wherein the means for adaptively applying the plurality of means for extracting digital content is responsive to information selected from the group consisting of published digital-content extraction algorithm accuracy statistics, credibility ratings, and acceptance levels.

22. The extractor of claim 12, wherein the means for adaptively applying a combination generates a more accurate interpretation of the underlying digital content than can be realized by separately applying each respective means for extracting.

23. The extractor of claim 22, wherein the means for adaptively applying further comprises a means for selecting information from the group consisting of ground-truthed data, categorization data, and digital content extraction accuracy statistics.

24. A method for extracting digital content, comprising:
reading a digital source;
identifying the digital source by type;
generating an acceptance level for each of a plurality of digital-content extraction algorithms based on a confidence value and a credibility rating associated with the accuracy of each of the plurality of digital-content extraction algorithms; and
applying a combination of at least two of the plurality of digital-content extraction algorithms based on the acceptance level to thereby generate extracted digital content of the digital source.

25. The method of claim 24, further comprising reading a confidence value associated with the use of each of a plurality of digital-content extraction algorithms designated to extract information from digital sources of the digital source type.

26. The method of claim 25, wherein reading a confidence value comprises the acquisition of a non-verified estimate of the accuracy of the associated digital-content extraction algorithm.

27. The method of claim 24, further comprising reading a credibility rating associated with the accuracy of each of the digital-content extraction algorithms designated to extract information from digital sources of the digital source type.

28. The method of claim 24, wherein generating an acceptance level comprises a normalization of the relative accuracy of the associated digital-content extraction algorithm when applied to a verified source of the digital source type.

29. The method of claim 24, wherein generating a more accurate interpretation of the digital source comprises using ground-truthed data, categorization data, a combination of digital-content extraction algorithms, and digital content extraction accuracy statistics.

30. The method of claim 24, wherein generating a more accurate interpretation of the digital source comprises combining a portion of at least one digital-content extraction algorithm with at least a portion of a separate digital-content extraction algorithm.

31. A method for assimilating a digital-content extraction algorithm in an intelligent digital content extractor, comprising:
identifying a digital-content extraction algorithm intended for integration with the intelligent digital content extractor;
reading a confidence value purporting the expected accuracy of the identified digital-content extraction algorithm when applied to a particular type of source data;
applying the digital-content extraction algorithm over source data;
generating a measure of the realized accuracy of the digital-content extraction algorithm over the source data; and
updating a knowledge base reflective of previously integrated digital-content extraction algorithms with a result of the generating step.

32. The method of claim 31, wherein applying the digital-content extraction algorithm comprises analyzing source data.

33. The method of claim 31, wherein generating a measure of the realized accuracy comprises formulating a function of the confidence value.

34. The method of claim 31, wherein updating comprises modifying ground-truthed correlation data.

35. The method of claim 31, wherein updating comprises generating an acceptance value.
